(19) United States
(12) Patent Application Publication
(10) Pub. No.: US 2007/0270258 A1
(43) Pub. Date: Nov. 22, 2007

(54) Single-axis drive, two-dimensional specimen position-shifting apparatus and methods

(76) Inventor: Dragos M. Stanescu, San Jose, CA (US)

Correspondence Address: SPECTRA-PHYSICS;Attn: Brian F. Swienton, 1335 Terra Bella Ave., Mountain View, CA, 94043, US

(21) Appl. No.: 11/438,542

(22) Filed: May 22, 2006

(51) Int. Cl. F16H 7/08; F16H 7/22

(52) U.S. Cl. 474/101

(57) ABSTRACT

A single-axis drive, two-dimensional specimen position-shifting apparatus includes a rotary drive mechanism drivingly coupled to a cam shaft to rotate it about a longitudinal axis. The cam shaft has a threaded portion around which a compatibly threaded extender can spin and a cam throw including a cam bearing surface portion of changing distance relative to the longitudinal axis as the cam shaft rotates. A stages bracket includes first and second portions operatively coupled to, respectively, the threaded extender and the cam bearing surface to impart concurrent movement of the stages bracket in orthogonal directions in response to rotation of the cam shaft. The threaded extender provides longitudinal displacement as the cam bearing surface portion provides lateral displacement, to the stages bracket. A target specimen, such as an optical element, is typically mounted to the stages bracket and moves in concert with it.

### TECHNICAL FIELD

The present disclosure relates generally to performing two-dimensional shifting of the position of a target specimen and, in particular, to methods of and systems for achieving low-noise, precise two-dimensional positioning of a target specimen, such as an optical element.

### BACKGROUND INFORMATION

Applications of solid state laser beams are numerous and include microlithography, target specimen marking, and via drilling. For many semiconductor microprocessing applications, diode pumped solid state lasers offer a technology of choice because of their superior reliability, low operating costs and excellent output characteristics. In particular, a combination of high peak power, excellent mode quality, and high long-term pointing stability enables the development of reliable, frequency tripled and quadrupled high repetition rate lasers with ever increasing energy UV outputs near 355 nm and 266 nm, respectively.

Various solid state gain media, such as Nd:YVO₄, Nd:YAG, and Nd:YLF, have been utilized to generate high power UV outputs using frequency multiplexing with various nonlinear crystals. Among these, Nd:YVO₄ has become a gain medium of choice for applications performed at very high repetition rates, ranging typically from 10 kHz to over 100 kHz. Frequency tripled lasers based on Nd:YVO₄ are now commercially available with UV output powers of over 4 W at 355 nm. Fourth harmonic power levels exceeding 2 W at 266 nm have also been demonstrated in practical systems, and interest has been growing in lasers with shorter wavelengths, such as the frequency-quintupled radiation near 213 nm and even shorter wavelengths. UV lasers based on other gain media, such as Nd:YAG, have been successfully power scaled as well, generally for applications requiring lower repetition rates but higher energies and/or longer pulse durations.

The increasing emphasis on power scaling at shorter wavelengths and higher repetition rates places difficult requirements on laser components. A major practical limitation to continued scaling of power is the deterioration in lifetime of key optical elements, both linear and nonlinear. In particular, laser-induced damage is known to compromise long-term operation of protective coatings, substrates, and nonlinear materials employed in frequency conversion processes when subjected to high peak and average power laser beams. The literature recounts various mechanisms that can lead to such damage, including thermal, photo-acoustic, and plasma effects. The damage is known to accelerate with use of higher power densities and shorter wavelengths, and is further exacerbated by the presence of defects on optical elements, which can form laser energy absorbing centers.

To date, development of damage-resistant high quality coatings suitable for high power operation in the UV lags well behind coatings available at visible wavelengths. As repetition rate is increased, single pulse damage is further aggravated by the potential for cumulative damage mechanisms. Thus, allowing a high power beam to pass through a single spot at the surface of a coated optical element or a nonlinear crystal for long periods of time is known to result in performance degradation, sometimes at power levels well below single pulse damage thresholds. Mechanisms suggested for mitigating such cumulative damage include formation of UV absorbing color centers and structural changes of the polished entrance/exit faces of the coated element. Generally, such degradations become more severe as a consequence of higher incident beam power densities and repetition rates and of shorter input and/or output wavelengths.

Nonlinear crystals employed in frequency converted, high repetition rate laser systems are especially susceptible to such cumulative damage, the consequence of which is an early onset of degradation in harmonic conversion efficiency. Furthermore, inhomogeneities present in any birefringment crystal can result in widely varying conversion efficiencies in different parts of the same crystal. Varying conversion efficiency is a problem that is exacerbated when high intensity focused beams and temperature tuning are used to optimize the harmonic generation process. Temperature nonuniformities caused throughout the crystal volume by varying distance from the thermal source or sink, contaminants, varying degrees of surface polish, and bulk irregularities can all over time compromise performance of the crystal. Even before the onset of actual damage, thermal effects caused by residual UV absorption can lead to thermal dephasing, which reduces the effective interaction length in the crystal and lowers frequency conversion efficiency.

Temperature and angle-tuned nonlinear borate crystals, such as LBO (lithium triborate), BBO (beta-barium borate), and the newly developed CLBO (cesium lithium borate) that are routinely used to produce third and fourth harmonic frequency conversion, are known to be subject to such thermal dephasing at high average powers. As repetition rates and pulse energies are increased, thermal dephasing can become an issue even for a material such as CLBO, which has a large thermal acceptance bandwidth. Although this effect may be temporary and can further be alleviated using active temperature controls, the implementation of such techniques becomes more complex and costly as powers are increased beyond certain levels.

In particular, because of the generally low thermal conductivity of isotropic crystals, the time constant for crystal temperature adjustment is too large to permit reliance on temperature adjustment as a sole means for maintaining constant levels of UV output at elevated power levels. Similarly, though some of the observed damage mechanisms in crystals and other optical elements may be annealed over time, strong thermal effects resulting from increasingly high absorption will eventually cause permanent damage and thereby require replacement of the element. Optical elements are expensive, and downtime of a laser undergoing damaged component replacement increases the cost caused by production stoppage.

As is the case for other coated optical elements, the damage to nonlinear optical elements is more pronounced and the damage threshold is lower, as the output wavelengths become shorter. This has been a major factor limiting achievement of efficient conversion to higher order harmonics at scaled power levels.

In recent years, considerable efforts have been carried out to mitigate laser-induced damage. These include improvements in the quality of optical substrates, surfaces, and coatings, as well as the development of new, more tolerant laser and nonlinear conversion designs. One particular approach commonly employed in commercial systems containing harmonic modules is to physically shift during system operation the position of the nonlinear crystal so that the incident beam continually encounters a fresh crystal volume before any crystal degradation can occur. Multiple methods have been implemented to accomplish shifting the location of beam incidence. Systems used to accomplish shifting the location of beam incidence typically use at least two motors to provide two-dimensional shifting or one motor to shift through more than one axis, the latter approach complicating the design and providing for additional parts that could wear out. In addition, use of software to track the position of a laser beam on the crystal may also further complicate and be a source of error in tracking the laser beam location on the crystal.

### SUMMARY OF THE DISCLOSURE

Various embodiments of apparatuses use and methods implement single-axis drive to perform two-dimensional shifting of the position of a specimen. According to one embodiment, a single-axis drive, two-dimensional specimen position-shifting apparatus comprises a rotary drive mechanism drivingly coupled to a cam shaft to rotate it about a longitudinal axis. The cam shaft has a threaded portion around which a compatibly threaded extender can spin and a cam throw including a cam bearing surface portion of changing distance, relative to the longitudinal axis, as the cam shaft rotates. A stages bracket includes first and second portions operatively coupled to, respectively, the threaded extender and the cam bearing surface to impart concurrent movement of the stages bracket in orthogonal directions in response to rotation of the cam shaft. The first portion is coupled in sliding engagement with the threaded extender to enable lateral displacement of the stages bracket in a direction transverse to the longitudinal axis, and to prevent the threaded extender from spinning in concert with the cam shaft and thereby impart to the stages bracket longitudinal displacement along the longitudinal axis of the cam shaft as it rotates. The second portion contacts the cam bearing surface portion to impart to the stages bracket lateral displacement in a direction transverse to the longitudinal axis as the cam shaft rotates.

According to another embodiment, a laser system comprises a laser beam that propagates along a beam axis for incidence on a target surface of a specimen. A rotary drive mechanism is drivingly coupled to a cam shaft to rotate it about a longitudinal axis that is transverse to the beam axis. The cam shaft has a threaded portion around which a compatibly threaded extender can spin and a cam throw including a cam bearing surface portion of changing distance, relative to the longitudinal axis, as the cam shaft rotates. A stages bracket includes first and second portions operatively coupled to, respectively, the threaded extender and the cam bearing surface to impart to the stages bracket concurrent movement in orthogonal directions transverse to the beam axis in response to rotation of the cam shaft. The specimen is operatively coupled to the stages bracket such that the target surface moves in concert with the stages bracket. The first portion is coupled in sliding engagement with the threaded extender to enable lateral displacement of the stages bracket in a direction transverse to the longitudinal axis, and to prevent the threaded extender from spinning in concert with the cam shaft and thereby impart to the stages bracket longitudinal displacement along the longitudinal axis of the cam shaft as it rotates. The second portion contacts the cam bearing surface portion to impart to the stages bracket lateral displacement in a direction transverse to the longitudinal axis as the cam shaft rotates. A chassis, with upper and lower mounting surfaces, encloses the laser beam and the target surface. The rotary drive mechanism is mounted to the lower mounting surface. A multi-stage bracket support assembly is mounted to the upper mounting surface and includes first and second stages that are movable along the orthogonal directions. The multi-stage bracket support assembly operatively secures the stages bracket to the upper mounting surface as the first stage moves in compliance with the longitudinal displacement of the stages bracket and the second stage moves in compliance with the lateral displacement of the stages bracket.

### BRIEF DESCRIPTION OF THE DRAWINGS

The present embodiments will become more fully apparent from the following description and appended claims, taken in conjunction with the accompanying drawings. Understanding that the accompanying drawings depict only typical embodiments and are therefore not to be considered to limit the scope of the disclosure, the embodiments will be described and explained with specificity and detail in reference to the accompanying drawings, herein described.

FIGS. 1A and 1B are exploded, isometric views from different vantage points of an embodiment of a single-axis drive, two-dimensional specimen position-shifting apparatus.

FIG. 2 is an isometric view of a single-axis drive, two-dimensional specimen position-shifting apparatus with part of its enclosure removed to show internal components.

FIG. 3 is the single-axis drive, two-dimensional specimen position-shifting apparatus of FIG. 2 shown with an attached target device holding bracket and mounted to an exemplary support structure.

FIG. 4 is an isometric view of two single-axis drive, two-dimensional specimen position-shifting apparatus installed in a chassis and supporting target specimen devices.

FIG. 5 is an isometric view of the underside of the chassis of FIG. 4.

FIG. 6A is a graph representing a two-dimensional path of movement of a target device holding bracket of the single-axis drive, two-dimensional specimen position-shifting apparatus of FIG. 3.

FIG. 6B is a two-dimensional representation of various available locations of incidence of a laser beam on a surface of a solid crystal component, which is a possible target device attached to the holding bracket of FIG. 3.

### DETAILED DESCRIPTION OF PREFERRED EMBODIMENTS

The embodiments of this disclosure will be best understood by reference to the drawings, wherein like parts are designated by like numerals throughout. It will be readily understood that the components of the embodiments as generally described and illustrated in the Figures herein could be arranged and designed in a wide variety of different configurations. Thus, the following more detailed description of various embodiments, as represented in the Figures, is not intended to limit the scope of the invention, as claimed, but is merely representative of various embodiments. While the various aspects of the embodiments are presented in drawings, the drawings are not necessarily drawn to scale unless specifically indicated. In addition, the steps of a method do not necessarily need to be executed in any specific order or even sequentially, unless otherwise specified.

The phrases “connected to,” “coupled to,” and “in communication with” refer to any form of interaction between two or more entities, including mechanical, electrical, magnetic, electromagnetic, fluid, and thermal interaction. Two components may be coupled to each other even though they are not in direct contact with each other. The term “in electrical communication with” is not to be construed to require coupling or physical connection, but only electrical signal coordination or the ability to “talk” electrically between components through a circuit.

Any industry that uses robotics or automated processing may favorably employ a single-axis, two-dimensional specimen position shifter in ways known in the art. This may include shifting conveyor belts to different locations to drop manufactured items of different types into varying locations or to place a particular circuit component in the proper place on a printed circuit board to repair a circuit or chip in the electronics and semiconductor industries. The possible applications are thus almost limitless in today's world of automated manufacturing processes and research facilities. Thus, while use of a single-axis drive mechanism may be used for shifting optical elements in lasers, as herein discussed in detail, the scope of the disclosure easily extends beyond any single implementation or embodiment of such a device and associated methods.

As one skilled in the art will appreciate, certain embodiments may be capable of achieving certain advantages over the known prior art, including some or all of the following: (1) providing for a two-dimensional specimen position-shifting apparatus that may be driven by a single-axis motor or driver, together with a simple set of motion translation structures; (2) minimizing the control hardware and software, and thus the number of potential errors in tracking and feedback regarding the structure to be shifted; and (3) where that structure is an optical element, simultaneously lengthening the life of that element, such as a laser crystal, thus reducing replacement and down-time costs. These and other advantages of various embodiments will be apparent upon reading the following.

One application for spatially distributing laser beam spots over a crystal volume is described in U.S. Pat. No. 6,890,474 to Gruber et al. (“the '474 patent”). The '474 patent describes use of algorithms for enhancing the lifetime of critical components in a laser system, including components such as the crystal through which a laser beam passes. These algorithms use functional and physical limits of the crystal, spot lifetime measurements, and laser parameters such as power, energy, repetition rate, input and output wavelengths, pulse duration, and beam divergence over which the crystal is expected to maintain a specified performance. Based on the input of these data and these measurements and parameters, software algorithms calculate initial maximum dwell times on indexed macro-spots and enable monitoring for sudden power degradations to be incorporated in real-time. Incorporation of initial maximum dwell times with real-time updates may be translated into shorter dwell times, causing the crystal to be moved to subsequent macro-spots having longer dwell times, thus using more of the crystal before it needs to be replaced.

Although use of algorithms may be useful, their development is time-consuming and entails for each additional crystal, adjustment for factors such as linearity, size, and application, in addition to the input parameters already mentioned. Miscalculations or the input of erroneous initial information for a given crystal or application, not to mention software glitches and computer hardware problems, may all lead to compromise of the crystal or other optical components, to include damage to coatings and infrastructure of a crystal, as well as continued operation in a macro-spot undergoing power degradation. Therefore, the simpler and more automated in mechanical structures the process of shifting is, the fewer the opportunities will be that these problems will shorten the longevity of a position shifting apparatus or system.

While the systems and methods of the present disclosure may be used in conjunction with the algorithms and software-controlled microcontrollers taught in the '474 patent, it will be apparent to one skilled in the art that the use of the latter may be greatly reduced by employment of the former.

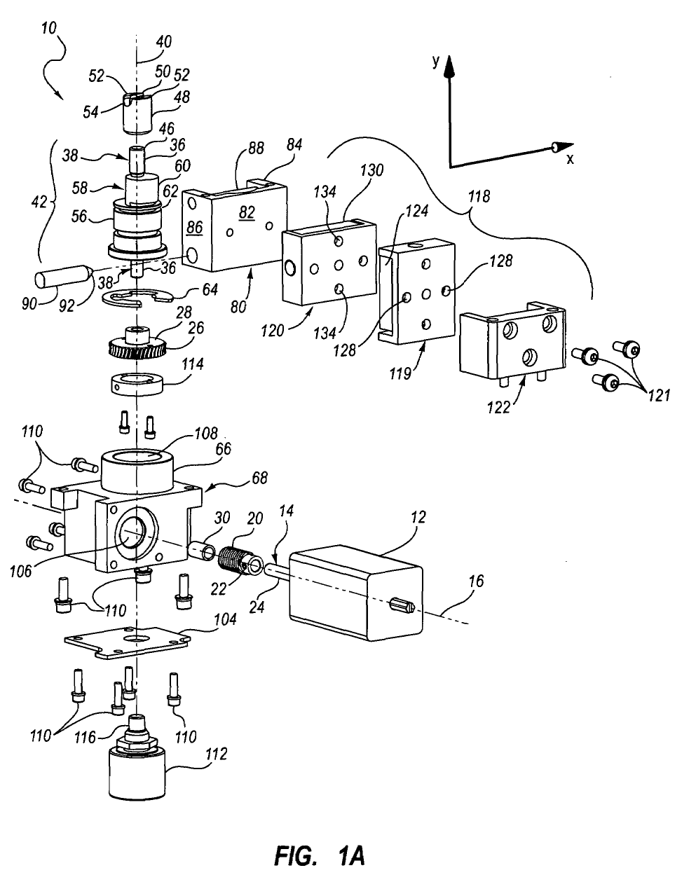

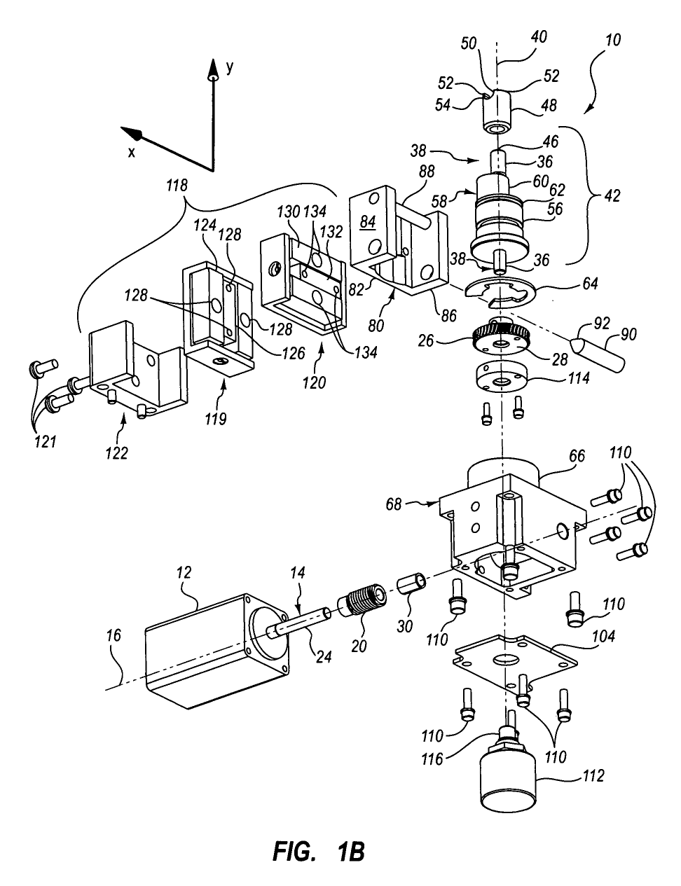

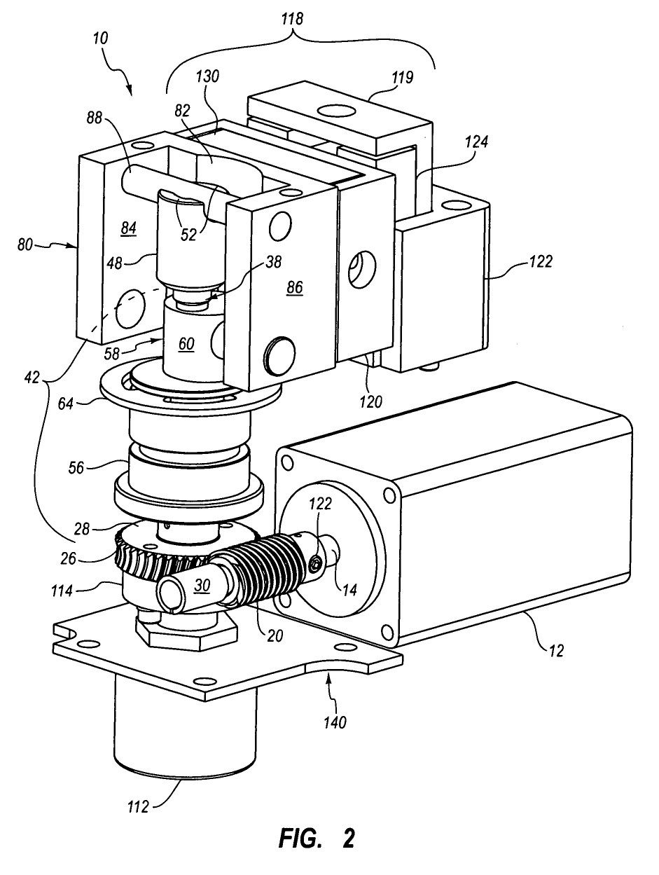

FIGS. 1A and 1B are exploded views of an embodiment of a single-axis drive, two-dimensional specimen position-shifting apparatus 10, and FIG. 2 shows the assembled apparatus 10. FIG. 3 shows apparatus 10 attached to a support structure 11. Apparatus 10 includes a motor 12 that drives a motor shaft 14 for rotation about a longitudinal axis 16. A worm 20 in the form of a sleeve positioned near the free end and secured by a set screw 22 on an outer surface 24 of motor shaft 14 engages teeth 26 of a worm gear 28. A motor shaft sleeve bearing 30 guides and supports the free end of shaft 14 and seals the shaft-worm interface to protect it from dirt and moisture. Worm gear 28 receives through its central opening, and is coupled to an outer surface 36 of, a cam shaft 38, which rotates about its longitudinal axis 40 as worm gear 28 turns in response to rotation of worm 20 driven by motor 12. Use of worm 20 allows leverage of gear ratios with worm gear 28 to provide power amplification from the motor 12 to the worm gear 28. Longitudinal axes 16 and 40 are transversely aligned relative to each other, in accordance with conventional worm gear drive configuration. Worm gear 28 rotates about longitudinal axis 40 in either a clockwise or a counter-clockwise direction, depending on whether motor 12 is driven in a forward or reverse direction.

A cam 42 includes cam shaft 38, which has a threaded distal end 46 to which a fork nut 48 extender is threadedly engaged for unrestricted rotation about longitudinal axis 40. Fork nut 48 has at its free end 50 two spaced-apart members 52 that define a generally U-shaped, open-ended slot 54. Cam 42 is supported on outer surface 36 of cam shaft 38 at a position between fork nut 48 and worm gear 28. Cam 42 includes a bearing and seal casing 56, which houses a bearing assembly (not shown) that facilitates the rotational movement of cam shaft 38. Cam 42 includes a throw 58 that is axially offset from longitudinal axis 40 and has an outer bearing surface 60 of changing radial distance from longitudinal axis 40 along an X-axis (FIGS. 1A and 1B) as cam shaft 38 rotates. Cam 42 also includes a large slot 62 between cam throw 58 and bearing and seal casing 56 into which a retaining ring 64 is inserted to secure the bearing and seal casing 56 below a throat 66 of and within a gear box 68, as shown in FIG. 3. Thus, the bearing assembly may be located between bearing and seal casing 56 and throat 66 or cam shaft 38. Gear box 68 is designed to additionally house worm 20 and worm gear 28, thereby sealing within it the lubricated rotary drive elements.

A U-shaped stages bracket 80 having a base portion 82 and spaced-apart, generally parallel side members 84 and 86 is slidably secured to support structure 11 (FIG. 3). A pin 88 is supported on either of its sides in apertures in side members 84 and 86, and a follower 90 is supported at one end by side member 86 and has a free end extending toward cam throw 58. Pin 88 and follower 90 are positioned on stages bracket 80 so that pin 88 passes through and rests in slot 54 of fork nut 48 and that a contact point 92 of follower 90 contacts outer bearing surface 60 of cam throw 58. Follower 90 moves stages bracket 80 along the X-axis in response to the changing radial distance of outer bearing surface 60 as cam shaft 38 rotates.

In operation, motor 12 turns worm 20 about its longitudinal axis 16 and thereby causes worm 20 to turn worm gear 28 and perforce cam shaft 38 about its longitudinal axis 40. Turning cam shaft 38 rotates cam 42 and its throw 58 such that outer bearing surface 60 applies to contact point 92 of follower 90 a radially directed force that imparts to stages bracket 80 lateral displacement along the X-axis. The lateral displacement is of an amount and in a direction corresponding to the amount and direction of radial displacement of cam throw 58 relative to longitudinal axis 40. The placement of pin 88 between members 84 and 86 of stages bracket 80 allows pin 88 to slide along slot 54 of fork nut 48 as stages bracket 80 undergoes lateral displacement. The lateral displacement of stages bracket 80 takes place along the X-axis, which is transverse to longitudinal axis 40, and in a horizontal direction, as shown in FIG. 2.

Turning cam shaft 38 also causes it to operate as a lead screw for fork nut 48, which is prevented by pin 88 from rotation in concert with the rotation of cam shaft 38. Fork nut 48 responds to rotation of cam shaft 38 by moving along its length either closer to or farther from cam 42, depending on the direction of rotation of worm gear 28. Pin 88 follows the linear movement of fork nut 48 and thereby causes longitudinal displacement of stages bracket 80. The longitudinal displacement of stages bracket 80 takes place along a Y-axis defined by longitudinal axis 40 and in a vertical direction, as shown in FIG. 2. The amount of displacement of main bracket 80 along the X-axis and Y-axis for each complete rotation of cam shaft 38 depends, for Y-axis displacement, on the thread pitch of distal end 46 of cam shaft 38 and, for X-axis displacement, on the degree of eccentricity of cam throw 58 of outer bearing surface 60. Each rotation of cam shaft 38 moves through a unit distance defined by the pitch width in the Y direction.

Therefore, the number of turns of cam shaft 38 corresponds to the X-Y position of stages bracket 80, to which a target device is operatively attached (FIG. 3). In sum, the X position is the lateral displacement of contact point 92 of follower 90, and the Y position is the longitudinal displacement of fork nut 48 at the distal end 46 of cam shaft 38 at a rate dictated by the thread pitch. Both X and Y positions change simultaneously as cam shaft 38 rotates.

Referring to FIGS. 1A, 1B, 2, and 3, position-shifting apparatus 10 is mounted to a support or mounting surface 100 of a system support structure 11 (FIG. 3) as follows. Gear box 68, as mentioned, houses worm 20, worm gear 28, and bearing and seal casing 56 (“rotary drive elements”), which are held in place by retaining ring 64. Gear box 68 with the rotary drive elements installed is mounted to the underside of surface 100 and is sealed shut by a plate 104. Gear box 68 has an aperture 106 through which motor shaft 14 enters to engage worm 20 with worm gear 28 and an aperture 108 through which cam shaft 38 extends to present fork nut 48 and cam 42 to stages bracket 80. Motor 12 is preferably secured to gear box 68 by bolts or other fasteners 110. A rotary encoder or a position transducer 112 is attached to plate 104 of gear box 68. A donut ring 114 having a circular counter-bore (not shown) is secured to the transducer side of worm gear 28 with an O-ring (not shown) positioned within the counter-bore to provide a protective seal for position transducer 112 from grease and dirt. Position transducer 112 includes a hollow stub shaft 116 that passes through the O-ring and operatively engages within worm gear 28 outer surface 36 of cam shaft 38, thereby enabling transducer 112 to track the number of turns of cam shaft 38 as it rotates.

Stages bracket 80 is mounted to support surface 100 by a multi-stage bracket support assembly 118 that accommodates the X-Y displacement imparted to stages bracket 80 by rotation of cam shaft 38. Bracket support assembly 118 includes a Y-axis module 119 that is slidingly coupled to an X-axis module 120. X-axis module 120 is slidingly coupled to stages bracket 80; and Y-axis module 119 is rigidly coupled by fasteners 121 to a support structure (or surface) mounting bracket 122, which is mounted to support surface 100 of system support structure 11. Y-axis module 119 and X-axis module 120 are substantially identical with, oriented orthogonal to, and coupled to allow relative movement to each other.

Specifically, Y-axis module 119 has a surface 124 within which a spring-biased slidable rail 126 extends in a direction along the Y-axis. Y-axis module 119 has apertures 128 that extend through surface 124 and slidable rail 126. X-axis module 120 has a surface 130 within which a spring-biased slidable rail 132 extends in a direction along the X-axis. X-axis module 120 has apertures 134 that extend through surface 130 and slidable rail 132. Spring biased slidable rails 126 and 132 allow X-Y movement as well as naturally rest at a starting location representing reference coordinates (X, Y)=(0, 0), relative to the longitudinal axes 16 and 40, before any motor 12 action.

Stages bracket 80 is mounted to X-axis module 120 with threaded fasteners (not shown) or other means secured through stages bracket 80 and into apertures 134 of slidable rail 132. X-axis module 120 is mounted to Y-axis module 119 with threaded fasteners (not shown) secured through apertures 134 of X-axis module 120 and into apertures 128 of slidable rail 126. These interconnections of the components of multi-stage bracket support assembly 118 operatively secure to system support structure 11 the components connected to the distal end of cam shaft 38. One skilled in the art will appreciate other means by which multi-stage bracket support assembly 118 may be interconnected for mutual orthogonal movement of X-axis module 120 and Y-axis module 119 and secure mounting to surface 100.

FIG. 3 shows an L-shaped specimen holding bracket 140 of a cantilever type having a first end 142 secured by bolts or other fasteners 144 to the top side of stages bracket 80 and a second, free end 146 having a surface 148 to which a specimen (not shown) can be mounted. Specimen position-shifting apparatus 10 is set in support structure 11 so that the rotary drive elements, which are placed within gear box 68, are located on the opposite side of support surface 100 from that where the specimen position-shifting elements are located. Such placement provides for reduced space required in the region in which shifting of the specimen occurs and effectively isolates multi-stage bracket support assembly 118 to keep it clean, away from the lubricated rotary drive elements.

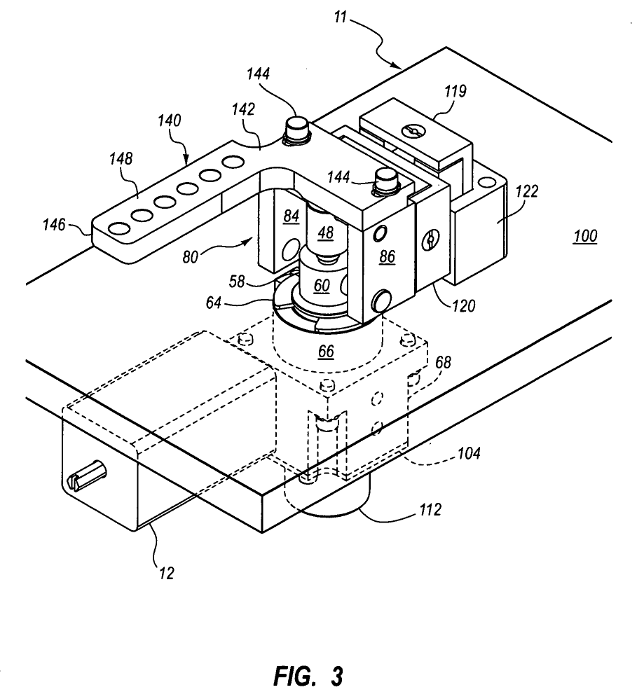

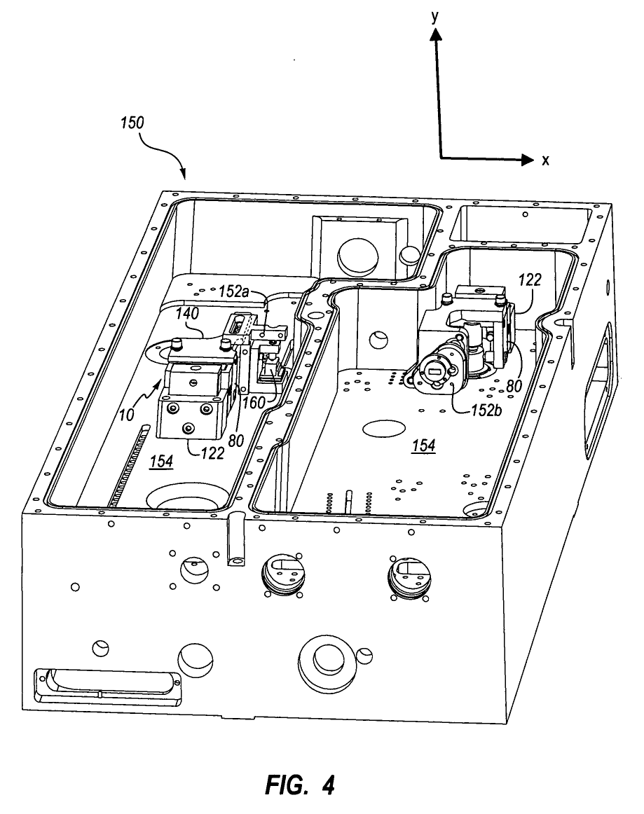

FIG. 4 is an isometric view of two, single-axis drive, two-dimensional shifting apparatuses 10 located within a laser chassis 150, with target specimen devices 152a and 152b displayed mounted on their respective holding brackets 140. The support structure mounting bracket 122 of each apparatus 10 is attached to an upper surface 154 of chassis 150. As so positioned, each target specimen device 152 will follow the X and Y movements of stages bracket 80. Additionally, FIG. 5 displays a lower surface 156 of chassis 150, showing the combination of motor 12, gear box 68, and position transducer 112 attached thereto. Specimen device 152a displayed in FIG. 4 is a laser crystal oven assembly 152a, which includes a solid crystal 160 oriented in the X-Y plane through which a laser beam may pass. Laser crystal oven assembly 152a produces the energy required to generate the laser beam, the assembly 152a preferably remaining free from contaminants. The laser beam produced may be from a fixed source.

Imparting two-dimensional specimen position shifting through a single longitudinal drive axis 40 makes for smooth shifting of crystal 160 without the vibration or noise normally associated with shifting imparted through dual-axis drives. Such vibration or noise may result not only in additional wear and tear of moving structures, but also in fluctuation of laser beam power levels associated with moving across the surface of a nonlinear crystal. Two-dimensional, position-shifting apparatus 10 dramatically reduces any such vibrations, especially for situations in which power required for shifting may be magnified through a worm 20 and worm gear 28 assembly. However, other means of power amplification known in the art, may of course be employed to drive cam shaft 38.

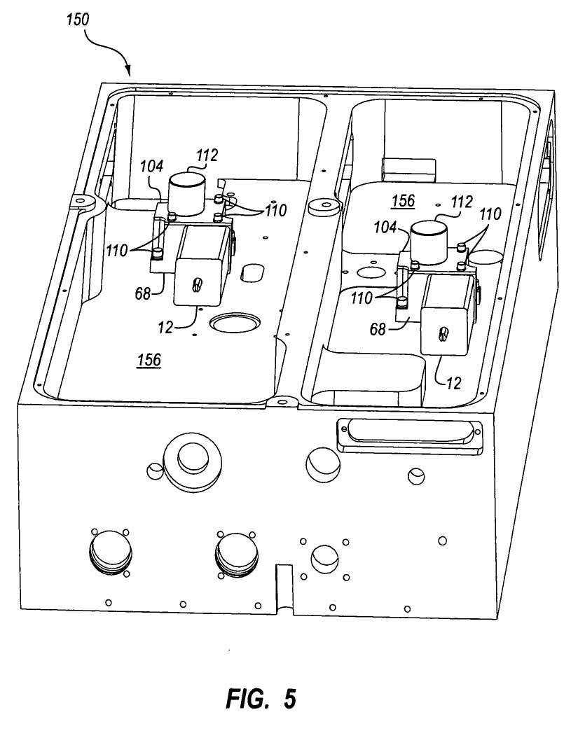

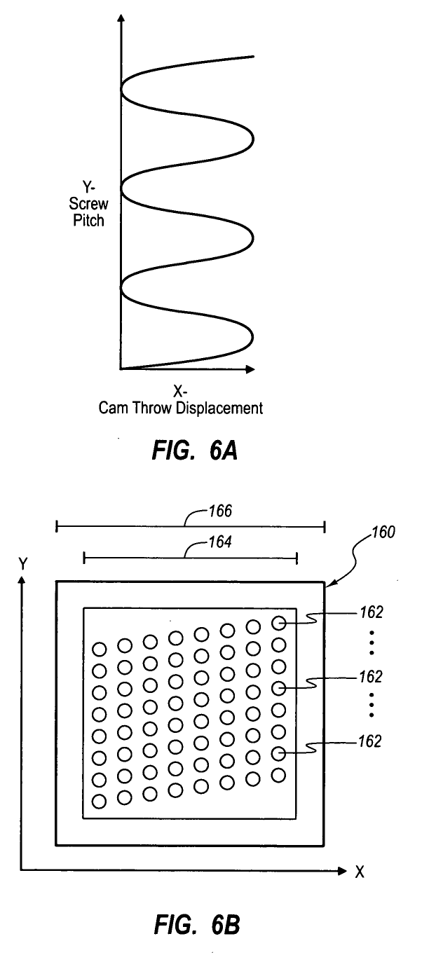

FIG. 6A is a two-dimensional representation of the path of movement described by stages bracket 80 in response to turning cam shaft 38. The path of movement of stages bracket 80 is sinusoidal because there is simultaneous displacement of stages bracket 80 in the X-axis (or lateral) direction dictated by the horizontal position of outer bearing surface 60 of cam throw 58 and in the Y-axis (or longitudinal) direction dictated by the vertical position of fork nut 48 extender on threaded distal end 46 of cam shaft 38. Both motions take place as a consequence of motor 12 rotating motor shaft 14 for a certain number of turns. Thus, the cam throw 58 width (i.e., its radial extension) and the pitch of the cam shaft 38 threads are coordinated to establish a sinusoidal path of movement of desired maximum length in the X-axis direction and pitch width distance in the Y-axis direction.

FIG. 6B is a two-dimensional representation of the various locations (or macro-spots) 162 available for a laser beam to propagate through a solid crystal 160, which is a target device 152 or an assembly that is held by bracket 140 mounted to stages bracket 80 of FIG. 4. The distance movable in the X-direction is a width 164 that represents the width of cam throw 58 in excess of the width of cam shaft 38. Width 164 is preferably shorter than the overall width 166 of crystal 160 so that cam throw 58 acts as a natural stop of the laser beam. Keeping the laser beam away from the edges of the crystal may ensure consistent generation of a laser beam of sufficient power and prevent damage to crystal 160 stemming from degeneration or cracking of its edges. Additionally, longitudinal movement of stages bracket 80 in response to the movement of fork nut 48 relative to rotation of cam shaft 38 moves crystal 160 such that the laser beam follows a slightly inclined raster scan type path, passing through subsequent rows along crystal 160 in the Y-direction. The distance between these rows is dictated by the pitch of the threads of cam shaft 38, which pitch is set so that a laser beam of certain diameter may pass through a discrete, fresh macro-spot 162 each time. This distance may also ultimately influence how far apart along the X-direction each macro-spot 162 may reside. Thus, the pitch (or laser beam diameter), together with width 164, usually dictates the number of total possible usable locations 162 on crystal 160.

For instance, FIG. 6B shows across crystal 160 sixty-four (64) locations 162 that are available for sequential passage of the laser beam. Assuming crystal 160 is sized 5×5 millimeters (mm), width 164 portion of cam throw 58 may be sized to, for example, 4 mm, which is 1 mm shorter than the width of crystal 160, leaving a 0.5 mm margin at the edges of crystal 160. If the pitch of the threads of cam shaft 38 is sized to 0.5 mm for a laser beam of 0.5 mm, a matrix of laser macro-spots 162 in FIG. 6B is produced, yielding 8×8 locations square, or 64 “macro-spots.” Assuming that through use of “microscanning” or “smearing” of each macro-spot 162 (microscanning or smearing is a technique that is described in the '474 patent and uses substantially the entirety of each macro-spot 162 as opposed to only that area encompassing the laser beam spot size), each macro-spot 162 may provide a life of about 500 hours, as a moderate estimate. Thus, use of each of the 64 macro-spots 162 on crystal 160 at this rate may lengthen the life of crystal 160 to 32,000 hours. This is only an example and is not meant to be limiting in any respect to the spirit and scope of this disclosure. As an additional note, single-axis drive, two-dimensional specimen position-shifter 10 may be used to execute the “microscanning” or “smearing” techniques referred to in the '474 patent. This may be accomplished by executing similar linear motion made by apparatus 10 at a micro-level, within each macro-spot 162 through which the laser beam passes.

Referring again to FIGS. 5, 6A, and 6B, position transducer 112 may receive a signal from a laser power meter (not shown) indicating the power of the laser beam at any given moment as it passes through crystal 160. The transducer 112, which through tracking the number of turns of cam shaft 38, may likewise track the spot location 162 where the laser beam is at all times, including when the laser beam begins to pass through a first location 162 used on crystal 160. One or more basic algorithms executed in machine readable code may provide the ability for such tracking. When the laser power meter indicates to transducer 112 that the power has dropped below a percentage threshold level (or some discrete pre-determined level), then transducer 112 may signal motor 12 to activate for a time sufficient to shift laser crystal assembly 152a (and thereby shift crystal 160) so that the laser beam passes through a fresh macro-spot 162. This provides a way to automate, largely through mechanical structure, the shifting of crystal 160 when the power of the laser beam is degraded.

Minimizing the use of software algorithms to track and control the laser beam location 162 on crystal 160 allows for simplicity of design and may lessen the chance of a software-related glitch that affects optimal power in the laser beam. Also, allowing motor 12 and associated rotary drive elements to essentially go to sleep during normal, non-shifting operation will conserve energy and extend the longevity of moving parts. Skilled persons will appreciate that worm gear 28 is self locking and, as a consequence, prevents external forces applied to cam 42 from changing its position set by operation of motor 12. The tightly fitted interconnection of the structures comprising the single longitudinal drive axis 40 allows such structures to start and stop motion abruptly, without slippage, thus providing accurate rotational position to transducer 112 at all times. This rotational position is used to also track the X-Y location 162 of the laser beam on crystal 160, as previously mentioned, so that the entire crystal 160 surface is used over its lifetime.

Those skilled in the art of robotics applications in a wide range of industries will appreciate that the need to shift optical elements in lasers likewise applies to robotics parts, to include optical elements and other micro-elements exposed to intense thermo, optical, or electrical power. Some applications may also apply to macro elements in robotics, in manufacturing, and in processing assemblies.

The terms and descriptions used herein are set forth by way of illustration only and are not meant as limitations. Those skilled in the art will recognize that many variations can be made to the details of the above-described embodiments without departing from the underlying principles of the invention. The scope of the invention should therefore be determined only by the following claims (and their equivalents) in which all terms are to be understood in their broadest reasonable sense unless otherwise indicated.

1. A single axis drive, two-dimensional specimen position-shifting apparatus, comprising:
a rotary drive mechanism drivingly coupled to a cam shaft to rotate it about a longitudinal axis, the cam shaft having a threaded portion around which a compatibly threaded extender can spin and a cam throw including a cam bearing surface portion of changing distance relative to the longitudinal axis as the cam shaft rotates;
a stages bracket including first and second portions operatively coupled to, respectively, the threaded extender and the cam bearing surface to impart concurrent movement of the stages bracket in orthogonal directions in response to rotation of the cam shaft;
the first portion being coupled in sliding engagement with the threaded extender to enable lateral displacement of the stages bracket in a direction transverse to the longitudinal axis and to prevent the threaded extender from spinning in concert with the cam shaft as it rotates, thereby imparting to the stages bracket longitudinal displacement along the longitudinal axis of the cam shaft as it rotates; and
the second portion contacting the cam bearing surface portion to impart to the stages bracket lateral displacement in a direction transverse to the longitudinal axis of the cam shaft as it rotates.

2. The specimen position-shifting apparatus of claim 1, further comprising:
a multi-stage bracket support assembly mounted to a support structure and including first and second stages that are movable along the orthogonal directions, the multi-stage bracket support assembly operatively securing the stages bracket to the support structure as the first stage moves in compliance with the longitudinal displacement of the stages bracket and the second stage moves in compliance with the lateral displacement of the stages bracket.

3. The specimen position-shifting apparatus of claim 2, wherein the multi-stage bracket support assembly comprises a support structure mounting bracket that is attached to the support structure, the first stage is coupled to the surface mounting bracket, and the second stage is operatively coupled to the stages bracket and to the first stage.

4. The specimen position-shifting apparatus of claim 1, further comprising a position transducer operatively coupled to the cam shaft, the position transducer tracking the number of turns of the cam shaft and thereby tracking the longitudinal and lateral displacements of the stages bracket.

5. The specimen position-shifting apparatus of claim 4, further comprising:
an optical element operatively attached to the stages bracket to move in correspondence to the longitudinal and lateral displacements of the stages brackets, the optical element including a crystal component positioned to receive an incident laser beam; and
a laser meter operatively associated with the position transducer to measure a power level of the incident laser beam propagating through a location on the crystal component, the position transducer providing a signal to activate the rotary drive mechanism to shift the incident laser beam on the crystal component to another location in response to a diminution of the power level below a threshold value.

6. The specimen position-shifting apparatus of claim 1, further comprising a specimen holding bracket coupled to the stages bracket to move in correspondence to the longitudinal and lateral displacement of the stages bracket, the specimen holding bracket including a mount to which a target specimen is attached.

7. The specimen position-shifting apparatus of claim 6, wherein the target specimen includes a crystal component positioned to receive an incident laser beam, the crystal component positioned in a plane having a first axis defined by the direction of longitudinal displacement of the stages bracket and a second axis defined by the direction of lateral displacement of the stages bracket.

8. The specimen position-shifting apparatus of claim 7, further comprising a laser oven assembly that is configured to house the crystal component positioned to receive an incident laser beam.

9. The specimen position-shifting apparatus of claim 7, wherein the changing distance of the cam bearing surface portion ranges between minimum and maximum values that define a cam throw width, and wherein the crystal component has a width dimension along the second axis, the cam throw width being smaller than the crystal component width.

10. The specimen position-shifting apparatus of claim 7, wherein:
the cam throw has a width defined by minimum and maximum values of the changing distance of the cam bearing surface portion along the second axis, and
the threaded portion of the cam shaft is characterized by a thread pitch defining a unit distance along the first axis,
so that, in response to each complete rotation of the cam shaft, the incident laser beam follows a beam path generally transverse to the second axis and, for successive rotations of the cam shaft, adjacent beam paths are separated along the first axis by the unit distance.

11. The specimen position-shifting apparatus of claim 10, wherein the incident laser beam has a beam width that is not greater than the unit distance so as to enable formation of nonoverlapping laser beam spots located on the adjacent beam paths.

12. The specimen position-shifting apparatus of claim 1, wherein the first portion is a pin.

13. The specimen position-shifting apparatus of claim 1, wherein the second portion is a follower.

14. The specimen position-shifting apparatus of claim 1, wherein the threaded extender comprises a forked nut.

15. The specimen position-shifting apparatus of claim 1, wherein the rotary drive mechanism comprises:
a worm gear having a plurality of first teeth and coupled to the cam shaft; and
a worm coupled to a motor shaft of a motor, the worm having a plurality of second teeth to drive the plurality of first teeth, and the second teeth and the first teeth having a gear ratio chosen to provide power magnification from the motor to the cam shaft.

16. A laser system comprising:
a laser beam that propagates along a beam axis for incidence on a target surface of a specimen;
a rotary drive mechanism drivingly coupled to a cam shaft to rotate it about a longitudinal axis that is transverse to the beam axis, the cam shaft having a threaded portion around which a compatibly threaded extender can spin and a cam throw including a cam bearing surface portion of changing distance relative to the longitudinal axis as the cam shaft rotates;
a stages bracket including first and second portions operatively coupled to, respectively, the threaded extender and the cam bearing surface to impart concurrent movement of the stages bracket in orthogonal directions transverse to the beam axis in response to rotation of the cam shaft, and the specimen coupled to the stages bracket so that the target surface moves in concert with the stages bracket;
the first portion being coupled in sliding engagement with the threaded extender to enable lateral displacement of the stages bracket in a direction transverse to the longitudinal axis and to prevent the threaded extender from spinning in concert with the cam shaft, thereby imparting to the stages bracket longitudinal displacement along the longitudinal axis of the cam shaft as it rotates;
the second portion contacting the cam bearing surface portion to impart to the stages bracket lateral displacement in a direction transverse to the longitudinal axis of the cam shaft as it rotates;
a chassis configured to enclose the laser beam and the target surface, the chassis including upper and lower mounting surfaces, the rotary drive mechanism mounted to the lower mounting surface; and
a multi-stage bracket support assembly mounted to the upper mounting surface and including first and second stages that are movable along the orthogonal directions, the multi-stage bracket support assembly operatively securing the stages bracket to the upper mounting surface as the first stage moves in compliance with the longitudinal displacement of the stages bracket and the second stage moves in compliance with the lateral displacement of the stages bracket.

17. The laser system of claim 16, wherein the multi-stage bracket support assembly comprises a surface mounting bracket, the first stage is coupled to the surface mounting bracket, and the surface mounting bracket is coupled to the upper mounting surface.

18. The laser system of claim 17, wherein the second stage is operatively coupled between the stages bracket and the first stage.

19. The laser system of claim 18, further comprising:
a specimen holding bracket coupled to the stages bracket to move in correspondence to the longitudinal and lateral displacement of the stages bracket, the specimen holding bracket including a mount to which the specimen is attached.

20. The laser system of claim 19, wherein the target surface is a surface of a crystal component positioned in a plane transverse to the beam axis, the plane having a first axis defined by the direction of longitudinal displacement of the stages bracket and a second axis defined by the direction of lateral displacement of the stages bracket.

21. The laser system of claim 20, wherein the changing distance of the cam bearing surface portion ranges between minimum and maximum values that define a cam throw width, and wherein the target surface of the crystal component has a width dimension along the second axis, the cam throw width being smaller than the width of the target surface.

22. The laser system of claim 20, wherein:
the cam throw has a width defined by minimum and maximum values of the changing distance of the cam bearing surface portion along the second axis, and
the threaded portion of the cam shaft is characterized by a thread pitch defining a unit distance along the first axis,
so that, in response to each complete rotation of the cam shaft, the incident laser beam follows a beam path generally transverse to the second axis and, for successive rotations of the cam shaft, adjacent beam paths are separated along the first axis by the unit distance.

23. The laser system of claim 22, wherein the incident laser beam has a beam width that is not greater than the unit distance so as to enable formation of nonoverlapping laser beam spots located on the adjacent beam paths.

24. The laser system of claim 20, further comprising a position transducer operably coupled to the cam shaft, the position transducer tracking the number of turns of the cam shaft and thereby tracking the longitudinal and lateral displacements of the stages bracket.

25. The laser system of claim 24, further comprising a laser meter operatively associated with the position transducer to measure a power level of the incident laser beam propagating through a location on the crystal component, the position transducer providing a signal to activate the rotary drive mechanism to shift the incident laser beam on the crystal component to another location in response to a diminution of the power level below a threshold value.

26. The laser system of claim 16, wherein the first portion is a pin.

27. The laser system of claim 16, wherein the second portion is a follower.

28. The laser system of claim 16, wherein the threaded extender comprises a forked nut.
